(19) United States
(12) Patent Application Publication
(10) Pub. No.: US 2005/0042415 A1
(43) Pub. Date: Feb. 24, 2005

(54) Protector for protecting a timber pole against sub-soil decay

(76) Inventors: Albin Alexander Wladyslaw Baecker, Westville (ZA); Michael Robert Behr, Durban (ZA)

Correspondence Address: Charles F Hauff Jr;Snell & Wilmer, 400 East Van Buren, Phoenix, AZ, 85004, US

(21) Appl. No.: 10/494,797

(22) PCT Filed: Oct. 25, 2002
(86) PCT No.: PCT/IB02/04431

(30) Foreign Application Priority Data
Nov. 2, 2001 (ZA) 2001/9081

(51) Int. Cl. B32B 3/06

(52) U.S. Cl. 428/99

(57) ABSTRACT

The invention relates to a field liner for protecting a timber pole against subsoil decay. The field liner includes a sleeve, that can be loosely located on a pole for covering the region of the pole to be protected, and a covering sheet that is secured to and extends from the sleeve in a configuration in which, with the sleeve located on a pole, the covering sheet can be tightly drawn and held around the sleeve for holding the sleeve tightly against the pole. The sleeve includes at least a flexible, liquid impermeable, non-biodegradable, synthetic plastics film material layer, whereas the covering sheet is formed of a flexible, non-biodegradable, woven synthetic plastics sheet material.

### FIELD OF INVENTION

The present invention relates to a protector for protecting a timber pole against sub-soil decay.

### BACKGROUND OF THE INVENTION

It is known, as a method of primary pre-treatment of a timber pole to be supported in a body of soil, to apply a protector, in the form of a field liner, to the pole for covering the region of the pole that will be disposed within the soil body. The field liner includes a sleeve, of a synthetic plastics material, which, in use, fits snugly around the pole along the region of the pole to be covered, the known method of fitting a field liner on a pole providing for the sleeve to be heat shrunk on the pole.

The synthetic plastics material forming a field liner generally comprises a liquid impermeable, non-biodegradable material such as polypropylene or a low-density polyethylene. By its application on a pole it covers the optimal fungal growth region of the pole, thereby regulating at sub-optimal levels the air and moisture contents of the said region, and isolating it from nitrogenous compounds that exist in soil, all of which are required for fungal growth to occur. The field liner thus specifically prevents fungal growth from occurring. Since it is applied in the form of a sleeve, of which the operative lower end is open, the transverse surface of the butt of the pole remains uncovered and by not encapsulating the butt, it cannot become anaerobic and, as such, the field liner also prevents subsoil decay by anaerobic bacteria.

The heat shrink method of applying a field liner on a pole, although effective, has proved to be difficult to carry out in practice, particularly in a cheap and time efficient manner and it is thus an object of this invention to provide a field liner in respect of which the application on a pole is facilitated.

It has also been found that preservatives in standing poles migrate downward through outer sapwood vessels and are then lost to the soil by leaching from the poles, particularly from longitudinal and transverse faces of the poles near the butt ends thereof and that are in soil contact. The preservative loss is reduced by known field liners, but it remains an object of this invention to ameliorate the problem of preservative loss still further.

### BACKGROUND OF THE INVENTION

According to the invention there is provided a field liner for protecting a timber pole against subsoil decay, which comprises a sleeve including at least a first layer of a flexible, liquid impermeable, nonbiodegradable synthetic plastics film material that can be loosely located on a pole for covering the region thereof to be protected; and a covering sheet of a flexible, non-biodegradable sheet material secured to and extending from the sleeve in a configuration in which, with the sleeve located on a pole, it can be tightly drawn and held around the sleeve for holding the sleeve tightly against the pole.

The said first layer of the sleeve may be formed of polypropylene film, although the said layer may be formed also of any other suitable synthetic plastics material. The material forming the said first layer may contain a dry film biocide therein for protecting the sleeve against preservative-resistant microorganisms. The material forming the said layer also may contain an insecticide compound therein that can protect the sleeve against termite attack, a typical insecticide compound being the pyrethroid insecticide, Deltamethrin.

The sleeve of the field liner of the invention may include a second layer that forms a laminate with the said first layer, the second layer comprising a flexible, liquid impermeable, non-biodegradable synthetic plastics film material that forms the operative outer layer of the sleeve and that has tear resistance qualities. As such, the said second layer of the sleeve may be of low-density polyethylene (LPDE). The material forming the said second layer also may contain an insecticide compound that can protect the sleeve against termite attack, a typical insecticide compound again being the pyrethroid insecticide, Deltamethrin.

A field liner that includes a sleeve formed of the said first layer, or formed of a laminate of the said first layer and the said second layer, is particularly suitable for use on poles containing a water borne wood preservative, such as a copper-chromearsenate, or the like.

Further according to the invention, the sleeve of the field liner of the invention may include a third layer formed of a flexible aluminum film that is vapor impermeable and that is laminated between the said first layer and the said second layer of the sleeve.

The said third layer renders the sleeve resistant to fume penetration and, as such, the field liner is rendered particularly suitable for use on poles containing an oil borne wood preservative such as creosote, pentachlorophenol, or the like.

The effective diameter of the sleeve may permit slidable location of the sleeve on either one of a particular diameter pole and a range of different diameter poles.

The covering sheet of the field liner of the invention typically comprises a rectangular sheet that has the sleeve attached thereto across the width thereof and that has a width not narrower than the length of the sleeve, the length of the rectangular sheet being such that it can be wound tightly around a pole on which the sleeve can be located with sufficient overlap to ensure effective covering of the sleeve for holding the sleeve tightly against the pole.

The covering sheet may be formed of a woven synthetic plastics sheet material, which material may be any one of polypropylene, polyethylene and high-density polyethylene, or the like. Preferably, the covering sheet may be a woven synthetic textile sheet of the type known as a geotextile fabric. The covering sheet accordingly has wear and abrasion resistance properties that will provide effective protection for the sleeve against being damaged during handling of a pole on which the field liner is applied and also during the location of the pole in a soil body.

The material forming the covering sheet also may contain an insecticide compound that can protect the covering sheet against termite attack, a typically insecticide compound again being the pyrethroid insecticide, Deltamethrin.

Further according to the invention, the covering sheet may have a plurality of tying straps secured thereto and extending therefrom in a configuration in which the straps can serve to tie the covering sheet in its operative configuration on a pole on which it is wound. The tying straps may be adapted to cooperate with buckles located on the covering sheet for tying the covering sheet around a pole.

The effective length of the sleeve of the field liner of the invention may be determined by the region of the pole to be covered thereby, being at least the region of the pole to be disposed sub-soil in the operative configuration of the pole. The length of the sleeve and, as such, the effective width of the covering sheet, particularly are such that, in the operative configuration of the field liner on a pole and with the pole supported in a body of soil, a segment of the covering sheet is disposed above the soil level of the body of soil. The projecting segment clearly can then serve to identify the required depth to which the pole must be located in a body of soil, which, in practice, will be determined by the length of the pole and the application of the pole. The segment of the covering sheet to be disposed above the soil surface, in the operative configuration of the field liner, may be formed of a woven UV resistant material.

The length of the sleeve and, as such, the effective width of the covering sheet, also may be such that, in the operative configuration of the field liner on a pole, a small segment thereof extends beyond the end of the pole covered thereby, the protecting segment permitting drawing together thereof in a configuration in which the passage of rain water via this end is still permitted. For this purpose, the covering sheet may be provided with a draw string arrangement that can be tightened. The draw string arrangement may be adapted to provide for the outer perimeter segment of a butt end of a pole, in the operative configuration of the field liner on a pole, to be covered to thereby prevent the loss of preservative from this end of the pole. The arrangement particularly serves to reduce leaching of creosote from a pole on which the field liner is applied, while still allowing rainwater to escape from the bottom end of the field liner. By not allowing rainwater to accumulate in the region of the pole butt, anaerobic conditions, which can induce bacterial growth to occur, is effectively prevented. The arrangement in effect provides also for the increased distribution of preservatives throughout the pole butt end, which is advantageous. By not fully encapsulating the butt end, rain water drainage from the between the field liner and the pole will continue to occur which is important for the reasons explained above.

The invention extends also to a field liner, in accordance with the invention, in combination with a pole, in which the field liner is applied to the pole by slidably locating the sleeve of the field liner over the pole to cover the region of the pole to be protected; tightly winding the covering sheet around the sleeve and, thereby, the pole on which the sleeve is located, for holding the sleeve tightly against the pole; and tying the covering sheet in its wound configuration around the pole.

This application of the field liner may provide also for either one of a staple and a nail to secure the location of the field liner on the pole. Particularly for a field liner having a segment to be disposed above the soil level of the soil body in which the pole is to be supported, the staple or nail can pass through the said segment.

For a field liner having a sleeve and a covering sheet that will extend beyond the end of a pole on which it is to be located, the method may provide for drawing together the extending segment of the field liner.

### BRIEF DESCRIPTION OF THE DRAWING

Further features of the invention are described hereafter, with reference to an example of the invention illustrated in the accompanying diagrammatic drawings. In the drawings:

FIG. 1 illustrates in three dimensions a first embodiment of a field liner, in accordance with the invention, and the method of applying the field liner on a timber pole;

FIG. 2 illustrates in side view and in more detail the method step illustrated in FIG. 1H;

FIG. 3 illustrates in side view an inspection method for inspecting a pole having a field liner, in accordance with the invention, applied thereto;

FIG. 4 illustrates in side view one of the benefits associated with the use of the field liner of FIG. 1;

FIG. 5 illustrates in cross-section the configuration of a segment of a sleeve for a second embodiment field liner, in accordance with the invention; and

FIG. 6 illustrates in cross-section the configuration of a segment of a sleeve for a third embodiment field liner, in accordance with the invention.

### DETAILED DESCRIPTION OF EXEMPLARY EMBODIMENTS

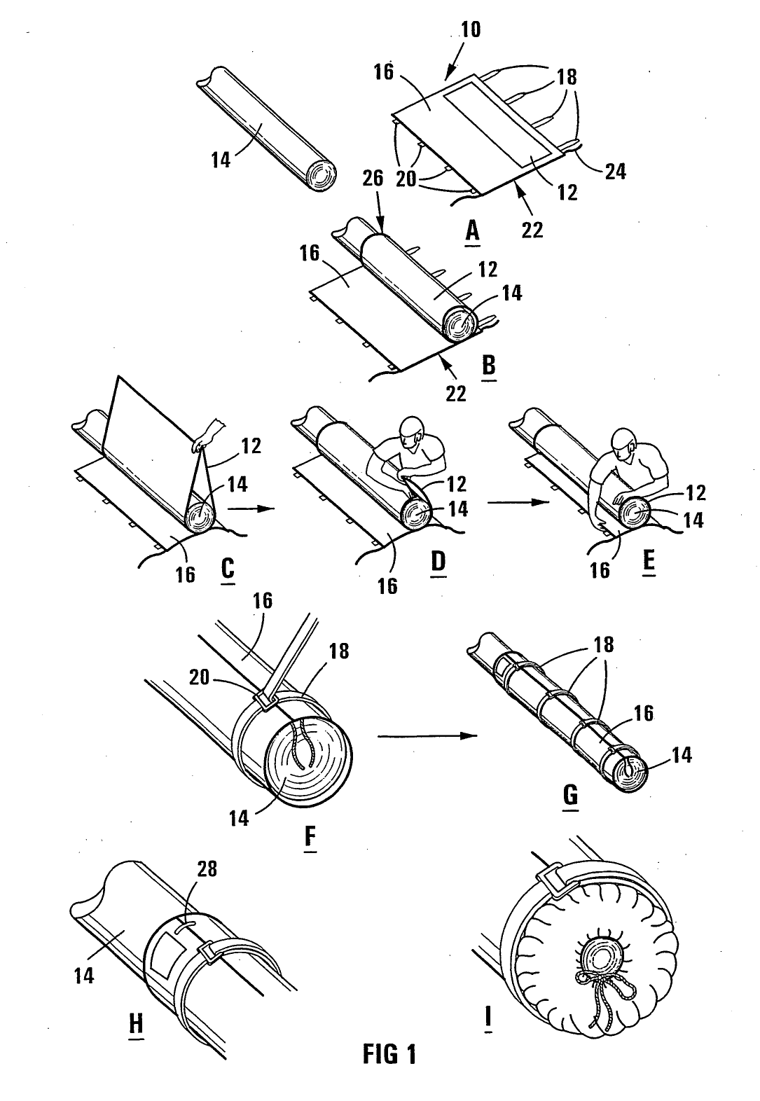

Referring initially to FIG. 1 of the drawings and, particularly, to FIG. 1A, a first embodiment of a field liner, in accordance with the invention, is designated generally by the reference numeral 10. The field liner 10 comprises a sleeve 12 formed of a layer of a flexible, liquid impermeable, non-biodegradable synthetic plastics material, typically of polypropylene. The sleeve 12 can be located loosely on a pole 14 that is to be supported in a soil body, the sleeve 12 providing particularly for the region of the pole which will be located within the soil body to be covered thereby.

The field liner 10 includes further a substantially rectangular covering sheet 16, typically formed of a woven synthetic textile material such as a material known in the trade as a geotextile. As is clear from FIG. 1A, the covering sheet 16 is slightly wider than the effective length of the sleeve 12, the sheet 16 being secured to and extending from the sleeve 12 in a configuration in which it can be wound around the sleeve after the location of the sleeve on a pole, for securely locating the sleeve and for holding the sleeve tightly around the pole.

The covering sheet 16 has straps 18 extending therefrom and that can cooperate with buckles 20 for securing the covering sheet 16 around a pole about which it is wrapped, as is described in more detail hereafter. The end 22 of the covering sheet 16 further has a seam through which a draw string 24 passes, the purpose thereof being described hereafter. The effective length of the covering sheet 16 is such that it can be wound around a pole with a sufficient overlap to effectively cover the sleeve 12. Thereby the sheet 16 provides for effective protection of the sleeve 12 while the sleeve fulfills its purpose of protecting a pole, on which the field liner 10 is applied, against subsoil decay.

For the application of the field liner 12 on the pole 14, the sleeve 12 is slidably displaced over the pole 14 to provide for the location thereof as shown in FIG. 1B.

For its proper location, the end 22 of the sheet 16 must extend beyond the end of the pole and with the correct width sheet 16, the end 26 of the sheet 16 will extend slightly beyond the region of the pole that will be disposed within the soil body in which the pole is to be supported, in use. This is referred to in more detail hereafter.

Following the correct location of the sleeve 12 on the pole, the sleeve is pulled tight as shown in FIG. 1C and then wrapped around the pole as shown in FIGS. 1D and 1E, thus providing for the snug location of the sleeve on the pole.

Thereafter, and as shown in FIGS. 1F and 1G, the covering sheet 16 is wound around the pole 14 into a partially overlapping configuration with itself in which the sleeve 12 will be completely covered by the sheet 16. The straps 18 and their associated buckles 20 then permit the covering sheet to be pulled tight around the pole, thereby providing for the location of the sleeve 12 around the pole to be secured and simultaneously for the sleeve to be held tightly against the pole.

In order to enhance the secure location of the covering sheet 16 with respect to the pole 14, staples 28 can be applied in the region of the sheet 16 that will be disposed above the soil level of the body of soil in which the pole 14 is to be supported, in use of the pole.

As shown in FIG. 11, the final step in the application of the field liner 10 on the pole 14 provides for the draw string 24 to be acted upon for pulling together the projecting end 22 of the sheet 16, this end thus folding the sleeve 12 around the operative bottom end of the pole as shown, while still providing for a passage via this end through which a liquid of low viscosity, such as rainwater, can drain. In this configuration the sleeve 12 will cover the outer peripheral segment of the bottom end of the pole 14, thereby reducing possible leaching of a wood preservative, or the like, from the pole through open ends of impregnated sapwood fibre vessels of the pole. Thereby, the long-term effectiveness of the wood preservative is enhanced, while it is also ensured that the wood preservative is not released into the soil body surrounding the pole's side or end.

The layer of material forming the sleeve 12 of the field liner 10 may contain a dry film biocide therein for protecting the sleeve against preservative resistant microorganisms, as well as an insecticide such as the pyrethroid insecticide, Deltamethrin, for protecting the sleeve against termite attack.

The covering sheet 16 also may contain an insecticide, such as the pyrethroid insecticide Deltamethrin, for protecting the sheet against termite attack. In its operative configuration, the covering sheet 16 protects the sleeve 12 against being damaged and, particularly, against being punctured, which may reduce the effectiveness of the sleeve for protecting the pole against subsoil decay. This protection will apply particularly after the application of the field liner on a pole and during subsequent handling of the pole and also when positioning the pole within a soil body in which it is to be supported. In this regard, an installation method may be utilized, for the effective location of a pole in a soil body, which will ensure that the wear and abrasion resistance properties of the sheet 16 is sufficient to ensure that the sleeve will not be damaged during this location, particularly while soil is compacted around the pole. Different installation methods clearly can be suitable for the purpose.

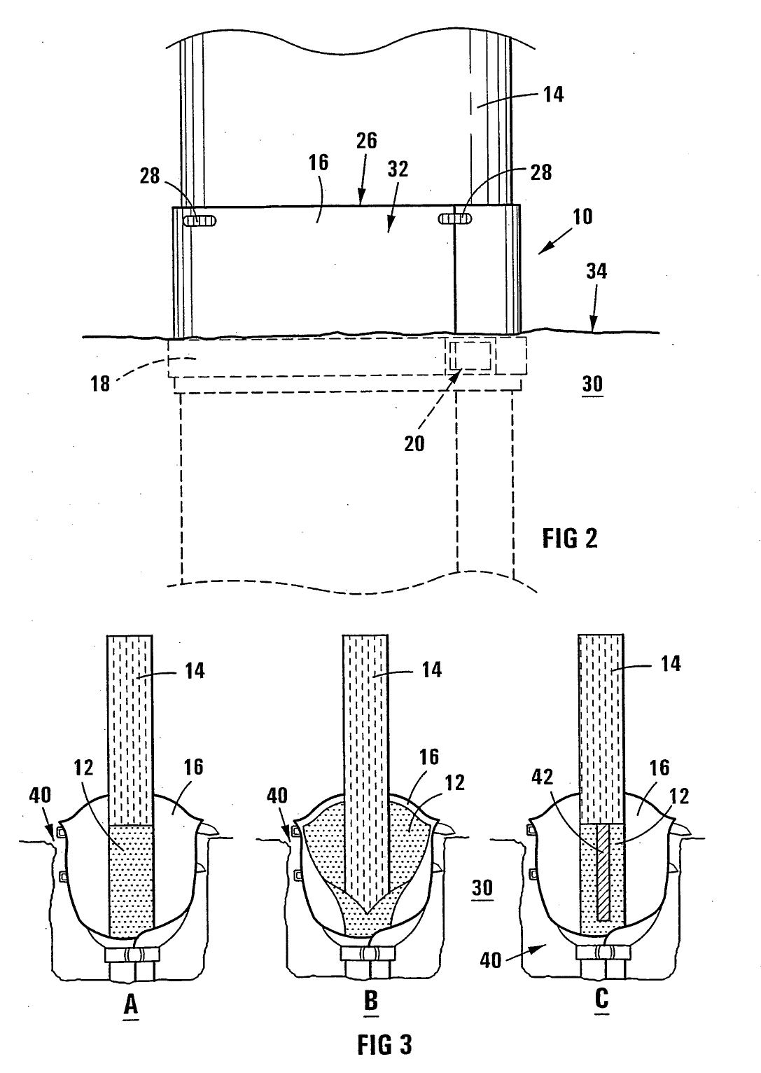

Referring to FIG. 2 of the drawings, the location of the pole 14 having a field liner 10 applied thereto, with reference to a soil body 30, is clearly illustrated. When correctly located, the operative top segment 32 of the covering sheet 16 projects above the soil level 34, while the operative top strap 18 is disposed immediately beneath the soil level 34. The staples 28 are located immediately adjacent to the operative top end 26 of the sheet 16, for holding the sheet 16 tight around the pole 14, as shown.

Referring to FIG. 3 of the drawings, in order to permit inspection of a pole 14 at desired time intervals, in order to check, if ever required, for fungal growth or other decay, a hole 40 is dug into the soil body 30 around the pole, following which exposed straps 18 are released for allowing the covering sheet 16 to be partially folded open around the pole 14 (see FIG. 3A). Thereafter, a slit is formed in the sleeve 12, as shown in FIG. 3B, which will allow an uncovered region of the pole to be inspected. Following inspection, the sleeve 12 is again folded around the pole 14 and is then resealed with the aid of a length of self-adhesive tape 42, or the like (see FIG. 3C). The sheet 16 is then again wrapped around the sleeve 12 and the pole 14 and is then tightened as before via the straps 18 and buckles 20. Thereafter, staples can again be used for securing the location of the field liner around the pole.

The above soil segment of the covering sheet 16 also can be used for receiving coded identification material associated with the field liner which, particularly, can identify batch numbers, dates of application on poles, and the like.

In addition to reducing possible wood preservative leaching from the pole 14, by drawing the end segment of the field liner together via the draw string 24, the possible displacement of the field liner with respect to the pole during location of the pole will be greatly inhibited.

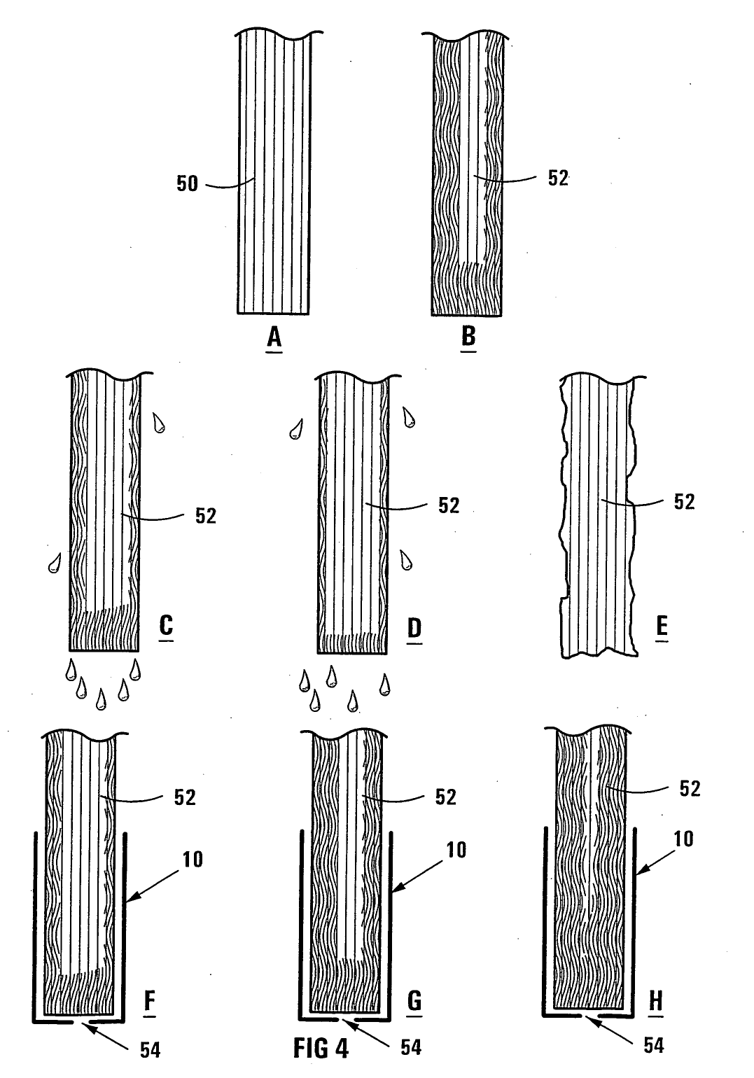

Referring particularly to FIG. 4 of the drawings, the benefits associated with the use of the field liner 10 in relation to wood preservative preservation, is illustrated. FIG. 4A illustrates an untreated pole 50, whereas FIG. 4B illustrates a treated pole 52, i.e. a pole having preservative squeezed therein, the preservative distribution providing for preservative to be located particularly in the outer sapwood regions thereof and in the butt end of the pole. FIGS. 4C, 4D and 4E illustrate the pole 52 at different times after treatment, FIGS. 4C and 4D illustrating leaching of the preservative from the pole, typically after one year and after 3 years, the preservative being leached into the soil body surrounding the relevant region of the pole. FIG. 4E illustrates the pole 52 after substantially all preservative has leached therefrom, the pole thus being allowed to rot.

FIGS. 4F, 4G and 4H illustrate the pole 52 when supported in a soil body while having a field liner 10 applied thereto as described, again at different times as suggested above. With the peripheral segment of the butt end of the pole covered by the field liner as shown, the preservative movement within the pole will provide for the preservative distribution in the region of the field liner to intensify, particularly due to the preservative being retained in the pole by the field liner. Only very limited, if any, leaching will occur via the passage 54 defined by the field liner, this passage being in register with the hardwood region of the pole within which only limited preservative movement will occur.

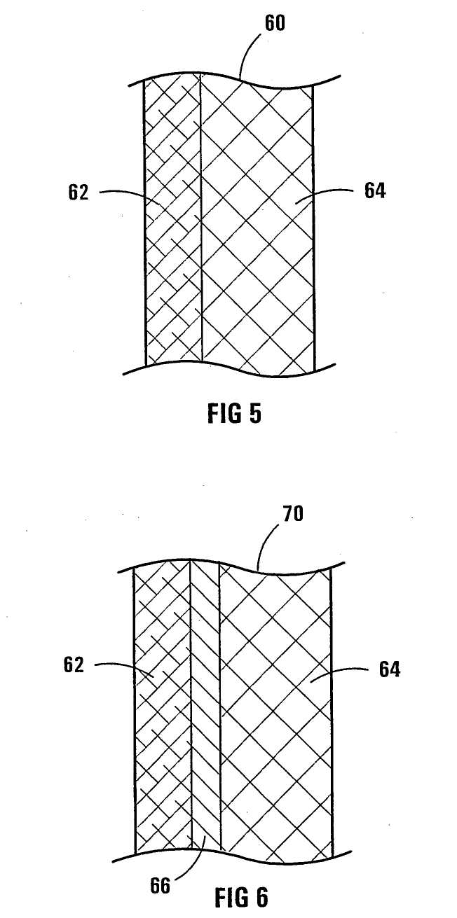

The sleeve 12 of the field liner 10 is described as being formed of a single layer of material only, this layer typically being formed of polypropylene and containing a dry film biocide therein. Insofar as this layer can easily be damaged, through tearing, or the like, upon being displaced onto a pole, a second embodiment field liner, in accordance with the invention, has a sleeve 60 (only a cross-sectional segment being shown in FIG. 5) formed of two layers of material, 62 and 64 respectively. The layer 62 is the equivalent of the layer of material forming the sleeve 12 of the field liner 10 and has the layer 64 externally laminated thereon. The layer 64 also is formed of a flexible liquid impermeable, non-biodegradable synthetic plastics film material. This layer has tear resistance qualities and, as such, typically is formed of low-density polyethylene. This layer 64 may have the pyrethroid insecticide Deltamethrin contained therein and serves therefore to protect the sleeve against damage, e.g. tearing, upon its application onto a pole and also to protect the sleeve against insecticide attack. The typical thickness of the layers 62 and 64 may be 50 micron and 200 micron respectively.

Insofar as the sleeves 12 and 60 as described above are liquid impermeable, field liners including such sleeves are particularly suitable for use on poles containing water borne wood preservatives, such as copper-chrome arsenate. In relation to their use on poles containing oil borne wood preservatives, such as creosote or pentachlorophenol, however, it has been found that preservative fumes can penetrate the sleeves and escape therefrom. In order to alleviate this problem, and as shown in FIG. 6, the field liner of the invention can be provided with a sleeve 70 (only a cross-sectional segment being shown) that includes the layers 62 and 64 of the sleeve 60, but that has a third layer 66, formed of aluminum foil, laminated between the layers 62 and 64. The aluminum foil is vapor impermeable and renders a field liner including a sleeve 70 suitable for use on poles containing oil borne wood preservatives. The typical thickness of the layers 62,66 and 64 of the sleeve 70 may be 50 micron, 20 micron and 150 micron respectively.

It will be understood, however, that the number of layers of material forming a sleeve for a field liner, in accordance with the invention, the thickness of the layers and the materials used for the layers, are greatly variable, being determined in practice by the individual requirements of a field liner in relation to its intended application.

Field liners 10 as above described and defined, and including any one of the sleeves 12,60 or 70, therefore, provides for effective protection of timber poles, while their application also is relatively cheap and time efficient.

The field liner 10 also permits inspection of a pole on which it has been applied at desired intervals, which is not possible in conjunction with known field liners that are heat shrunk onto a pole.

The exact construction of the field liner of the invention, as well as the method whereby it is applied on a pole, clearly can be varied in various different respects and the invention extends also to all possible different configuration field liners which still incorporate the essential principles of the invention as herein defined, as well as to the specific method of applying the field liner on a pole as described above and any variations of this method.

1. A field liner for protecting a timber pole against sub-soil decay, which comprises
a sleeve including at least a first layer of a flexible, liquid impermeable, non-biodegradable synthetic plastics film material that can be loosely located on a pole for covering the region thereof to be protected; and
a covering sheet of a flexible, non-biodegradable sheet material secured to and extending from the sleeve in a configuration in which, with the sleeve located on a pole, it can be tightly drawn and held around the sleeve for holding the sleeve tightly against the pole.

2. A field liner as claimed in claim 1, in which the said first layer of the sleeve is formed of polypropylene film.

3. A field liner as claimed in claim 1, in which the material forming the said first layer contains a dry film biocide therein for protecting the sleeve against preservative-resistant microorganisms.

4. A field liner as claimed in claim 1, in which the material forming the said first layer contains an insecticide compound therein that can protect the sleeve against termite attack.

5. A field liner as claimed in claim 1, in which the sleeve of the field liner includes a second layer that forms a laminate with the said first layer, the second layer comprising a flexible, liquid impermeable, non-biodegradable synthetic plastics film material that forms the operative outer layer of the sleeve and that has tear resistance qualities.

6. A field liner as claimed in claim 5, in which the said second layer of the sleeve is formed of a low density polyethylene.

7. A field liner as claimed in claim 5, in which the material forming the said second layer of the sleeve contains an insecticide compound that can protect the sleeve against termite attack.

8. A field liner as claimed in claim 5, in which the sleeve of the field liner includes a third layer formed of a flexible aluminum film that is vapor impermeable and that is laminated between the said first layer and the said second layer of the sleeve.

9. A field liner as claimed in claim 1, in which the effective diameter of the sleeve permits slidable location of the sleeve on either one of a particular diameter pole and a range of different diameter poles.

10. A field liner as claimed in claim 1, in which the covering sheet comprises a rectangular sheet that has the sleeve attached thereto across the width thereof and that has a width not narrower than the length of the sleeve, the length of the rectangular sheet being such that it can be wound tightly around a pole on which the sleeve can be located with sufficient overlap to ensure effective covering of the sleeve for holding the sleeve tightly against the pole.

11. A field liner as claimed in claim 1, in which the covering sheet is formed of a woven synthetic plastics sheet material.

12. A field liner as claimed in claim 11, in which the covering sheet is formed of any one of polypropylene, polyethylene and high density polyethylene.

13. A field liner as claimed in claim 1, in which the material forming the covering sheet contains an insecticide compound that can protect the covering sheet against termite attack.

14. A field liner as claimed in claim 1, in which the covering sheet has a plurality of tying straps secured thereto and extending therefrom in a configuration in which the straps can serve to tie the covering sheet in its operative configuration on a pole on which it is wound.

15. A field liner as claimed in claim 14, in which the tying straps can cooperate with buckles located on the covering sheet for tying the covering sheet around a pole.

16. A field liner as claimed in claim 1, in which the effective length of the sleeve is determined by the region of the pole to be covered thereby, being at least the region of the pole to be disposed sub-soil, in the operative configuration of the pole.

17. A field liner as claimed in claim 16, in which the length of the sleeve and the effective width of the covering sheet are such that, in the operative configuration of the field liner on a pole and with the pole supported in a body of soil, a segment of the covering sheet is disposed above the soil level of the body of soil.

18. A field liner as claimed in claim 17, in which the said segment of the covering sheet is formed of a woven UV resistant material.

19. A field liner as claimed in claim 1, in which the length of the sleeve and the effective width of the covering sheet are such that, in the operative configuration of the field liner on a pole, a small segment thereof extends beyond the end of the pole covered thereby, the projecting segment permitting drawing together thereof in a configuration in which the passage of rain water via this end is still permitted.

20. A field liner as claimed in claim 19, in which the said end of the covering sheet is provided with a draw string arrangement that can be tightened for the purpose.

21. A field liner as claimed in claim 20, in which the draw string arrangement is adapted to provide for the outer perimeter segment of a butt end of a pole, in the operative configuration of the field liner on a pole, to be covered to thereby prevent the loss of preservative from this end of the pole.

22. A field liner as claimed in claim 1, in combination with a pole, in which the field liner is applied to the pole by slidably locating the sleeve of the field liner over the pole to cover the region of the pole to be protected; tightly winding the covering sheet around the sleeve and, thereby, the pole on which the sleeve is located, for holding the sleeve tightly against the pole; and tying the covering sheet in its wound configuration around the pole.

23. A field liner in combination with a pole, as claimed in claim 22, in which the application of the field liner provides for either one of a staple and a nail to secure the location of the field liner on the pole.

24. (CANCELLED)
